(19) United States
(12) Patent Application Publication
(10) Pub. No.: US 2009/0271377 A1
(43) Pub. Date: Oct. 29, 2009

(54) SYSTEM AND METHOD FOR MEDICAL EPISODE RECREATION

(75) Inventors: Pedro Martinez, Boca Raton, FL (US); Noel Guillama, Wellington, FL (US)

Correspondence Address: Gregory A. Nelson;Novak Druce & Quigg LLP, 525 Okeechobee Blvd, Suite 1500, West Palm Beach, FL, 33401, US

(73) Assignee: The Quantum Group, Inc., Wellington, FL (US)

(21) Appl. No.: 12/427,190

(22) Filed: Apr. 21, 2009

Related U.S. Application Data
(60) Provisional application No. 61/047,612, filed on Apr. 24, 2008.

(51) Int. Cl. G06F 17/30

(52) U.S. Cl. 707/3; 707/1; 707/9; 707/104.1; 707/E17.001; 707/E17.005; 707/E17.014; 707/E17.044

(57) ABSTRACT

A system for recreating point-in-time medical episodes is provided. The system can comprise one or more electronic data processors and a network interface connected with the one or more electronic data processors for communicatively linking the one or more processors with a plurality of databases containing patient data corresponding to a particular patient. The system can also include an episode recreation module configured to execute on the more or more processors in order to integrate the patient data by correlating the patient data to a particular point-in-time.

### CROSS-REFERENCE TO RELATED APPLICATIONS

This application claims the benefit of U.S. Provisional Patent Application No. 61/047,612, which was filed Apr. 24, 2008, and which is incorporated herein in its entirety.

### FIELD OF THE INVENTION

The present invention is related to the fields of data integration and processing, and more particularly, to integrating and processing data derived from a variety of sources so as to recreate point-in-time medical episodes, treatments, and results.

### BACKGROUND OF THE INVENTION

In today's society, there has been a tremendous growth in medical advances and technologies, which have ultimately led to improved treatments, longer lifespans, and better medications. However, when attempting to provide medical care to a particular patient, it is important to be able to have that patient's medically-related data readily available. Currently, when a patient goes to a hospital for medical treatment, a variety of records are created containing information such as physician notes, medical imagery, lab test results, vital signs information, and prescribed medications. These records are often maintained and stored in different databases by multiple people and/or entities. For every subsequent visit for treatment, particularly to a different hospital or different physician, the maintenance of the patient's records becomes even more widely dispersed, being maintained on ever more unrelated databases.

When a patient is being treated, it is very important to know a history of the patient's medical episodes over a given period of time and to be able to recreate those episodes so as to ensure more effective treatment. In order to compile a patient's history, one must do so by accessing and combining a multitude of data sources residing in different locations. In trying to compile this information, a variety of inefficiencies are created such as delayed patient care, increased costs, data and diagnostic inaccuracies, and unnecessary increases in labor resources expended. As a result, there is a need for a more effective and efficient means of accessing, integrating, analyzing, and recreating a patient's medical history and episodes.

### SUMMARY OF THE INVENTION

The present invention is directed to systems and methods for accessing and integrating patient data from a variety of data sources, and using the integration to correlate the patient data to a particular time period or point-in-time. The correlation of the patient data to a particular point-in-time allows for the recreation of medical episodes.

One embodiment of the invention is a system for recreating point-in-time medical episodes. The system can comprise one or more electronic data processors and a network interface connected with the one or more electronic data processors for communicatively linking the one or more processors with a plurality of databases containing patient data corresponding to a particular patient. The system can also include an episode recreation module configured to execute on the more or more processors in order to integrate the patient data by correlating the patient data to a particular point-in-time.

Another embodiment of the invention is a computer-based method for recreating point-in-time medical episodes. The method can include accessing a plurality of databases containing patient data corresponding to a particular patient. The method can also include integrating the patient data by correlating the patient data to a particular point-in-time or time period.

Yet another embodiment of the invention is a computer-readable storage medium that contains computer-readable code that when loaded on a computer causes the computer to perform the following steps: accessing a plurality of databases containing patient data corresponding to a particular patient; and, integrating the patient data by correlating the patient data to a particular point-in-time or time period.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of a system for recreating point-in-time medical episodes, according to one embodiment of the invention.

FIG. 2 is a flowchart of steps in a method for recreating point-in-time medical episodes, according to another embodiment of the invention.

### DETAILED DESCRIPTION

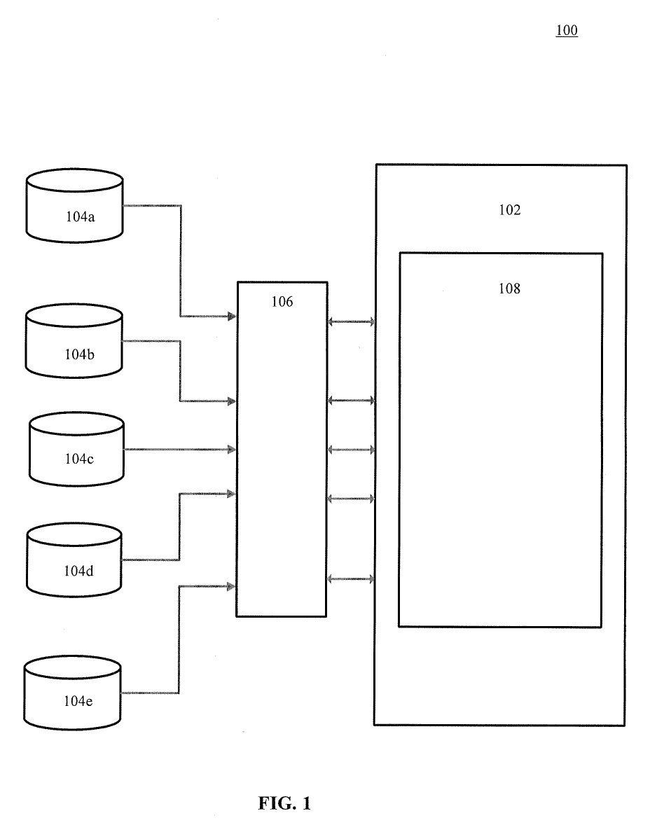

Referring initially to FIG. 1, a system 100 for recreating point-in-time medical episodes, according to one embodiment of the invention, is schematically illustrated. The system includes one or more electronic data processing elements 102. The system 100 further includes a plurality of databases 104 containing patient data corresponding to a particular patient. Although five databases 104a-e are shown, it will be apparent to one of ordinary skill based on the description that a greater or fewer number of databases can be utilized.

The system 100 further includes a network interface 106 which is communicatively connected with the one or more electronic data processing elements 102. As shown, the network interface 106 communicatively links the one or more electronic data processing elements 102 to each of the databases 104a-e. The system 100 also includes an episode recreation module 108, which, can be implemented as computer-readable code configured to execute on the one or more electronic data processing elements 102.

Alternatively, the episode recreation module 108 can be implemented in hardwired, dedicated circuitry for performing the operative functions described herein. In yet another embodiment, however, the episode recreation module 108 can be implemented in a combination of hardwired circuitry and computer-readable code.

Through the network interface 106, the databases 104a-e can be accessed by the episode recreation module 108. The databases 104a-e can include a physician notes database, which can comprise notes that a physician takes before, during, or after treatment. The databases 104a-e can also include a medical images database, including for example MRIs, CT scans, X-rays, and other imagery. Additionally, the databases 104a-e can include a lab results database, containing for example blood results, cultures, and other lab results. Furthermore, the databases 104a-e can include a vital signs database, including various vital statistics of a particular patient. The databases 104a-e can also include a medications database, containing, for example, the various medications that a patient took during a course of treatment.

Operatively, the episode recreation module 108 aggregates and integrates the patient data derived from the databases 104a-e by correlating the patient data to a particular point-in-time. The episode recreation module 108 can be configured to generate a patient-specific episode recreation data collection template (ERDCT). According to a particular embodiment, in generating the ERDCT, the episode recreation module 108 is configured to create a matrix, where the matrix comprises rows corresponding to time and columns corresponding to patient data. For example, the columns can include patient data selected from physician notes, medical images, lab results, vital signs, and/or medications, and the rows can include different types of time measurements. The episode recreation module 108 alternately can be configured to generate other data structures and create different data representations that are designed to facilitate the correlating of patent data according to specific time periods or points-in-time.

According to another embodiment, the episode recreation module 108 can be further configured to time stamp and/or validate the patient data that it accesses from the databases 104a-e. The episode recreation module 108 can also be configured to search the databases 104a-e based on window-in-time parameters, where the window-in-time parameters specify a time interval. According to yet another embodiment, the episode recreation module 108 can be further configured to create at least one of a privacy restriction and a security restriction for a particular set of patient data.

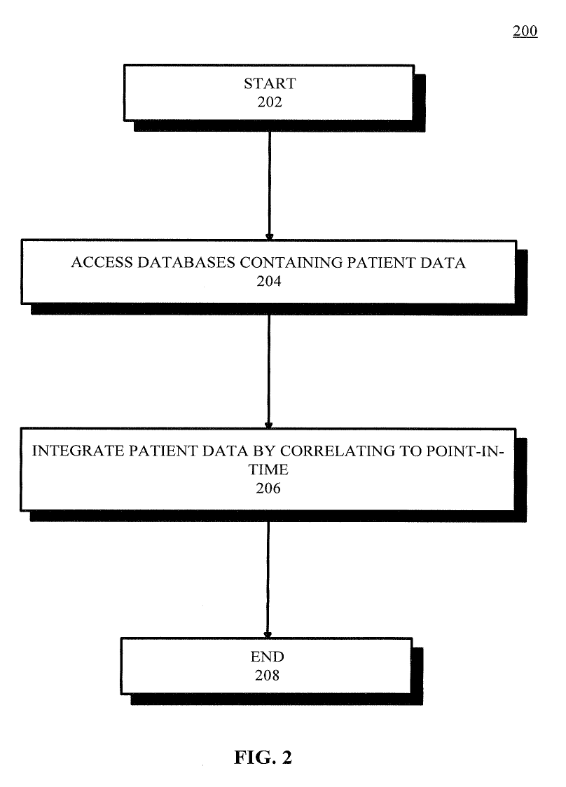

Referring now to FIG. 2, a flowchart is provided that illustrates certain method aspects of the invention. The flowchart depicts steps of a method 200 for recreating point-in-time medical episodes. The method 200 illustratively includes, after the start step 202, accessing a plurality of databases containing patient data corresponding to a particular patient at step 204. The method 200 also includes integrating the patient data by correlating the patient data to a particular point-in-time at step 206. The method 200 illustratively concludes at step 208.

According to another embodiment, the method 200 can further include, at the integrating step 206, generating a patient-specific episode recreation data collection template (ERDCT). Additionally, in generating the ERDCT, the ERDCT, can, in one embodiment, include creating a matrix, where the matrix comprises rows corresponding to time and columns corresponding to patient data. For example, the columns can include patient data selected from physician notes, medical images, lab results, vital signs, and/or medications, and the rows can include varying time measurements. Moreover, the step of integrating 206 also can include time stamping and/or validating the patient data.

According to yet another embodiment, the method 200 can further include searching the databases based on window-in-time parameters, the window-in-time parameters specifying a time interval. The method 200 can further include creating at least one of a privacy restriction and a security restriction for a particular set of patient data.

The invention, as already mentioned, can be realized in hardware, software, or a combination of hardware and software. The invention can be realized in a centralized fashion in one computer system, or in a distributed fashion where different elements are spread across several interconnected computer systems. Any type of computer system or other apparatus adapted for carrying out the methods described herein is suitable. A typical combination of hardware and software can be a general purpose computer system with a computer program that, when being loaded and executed, controls the computer system such that it carries out the methods described herein.

The invention, as already mentioned, can be embedded in a computer program product, such as magnetic tape, an optically readable disk, or other computer-readable medium for storing electronic data. The computer program product can comprise computer-readable code, (defining a computer program) which when loaded in a computer or computer system causes the computer or computer system to carry out the different methods described herein. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The preceding description of preferred embodiments of the invention have been presented for the purposes of illustration. The description provided is not intended to limit the invention to the particular forms disclosed or described. Modifications and variations will be readily apparent from the preceding description. As a result, it is intended that the scope of the invention not be limited by the detailed description provided herein.

We claim:

1. A computer-based method for recreating point-in-time medical episodes, the method comprising:
accessing a plurality of databases containing patient data corresponding to a particular patient;
integrating the patient data by correlating the patient data to a particular point-in-time.

2. The method of claim 1, wherein the integrating step comprises generating a patient-specific episode recreation data collection template (ERDCT).

3. The method of claim 2, further comprising creating a matrix, wherein the matrix comprises rows corresponding to time and columns corresponding to patient data.

4. The method of claim 1, wherein the integrating step further comprises at least one of time stamping and validating the patient data.

5. The method of claim 1, further comprising searching the databases based on window-in-time parameters, wherein the window-in-time parameters specify a time interval.

6. The method of claim 1, further comprising creating at least one of a privacy restriction and a security restriction for a particular set of patient data.

7. The method of claim 1, wherein the plurality of databases comprise at least one of a physician notes database, a medical images database, a lab results database, a vital signs database, and a medications database; and wherein the step of accessing comprises retrieving at least one of physician notes from the physician notes database, medical images from the medical images database, lab results from the lab results database, vital signs from the vital signs database, and medications from the medications database.

8. A computer-based system for recreating point-in-time medical episodes, the system comprising:
at least one electronic data processor;
a network interface connected with the at least one electronic data processor for communicatively linking the at least one electronic data processor with a plurality of databases containing patient data corresponding to a particular patient; and
an episode recreation module configured to execute on the at least one data processor for integrating the patient data by correlating the patient data to a particular point-in-time.

9. The system of claim 8, wherein the episode recreation module is configured to generate a patient-specific episode recreation data collection template (ERDCT).

10. The system of claim 9, wherein the episode recreation module is configured to create a matrix, wherein said matrix comprises rows corresponding to time and columns corresponding to patient data.

11. The system of claim 8, wherein the episode recreation module is further configured to time stamp and validate the patient data.

12. The system of claim 8, wherein the episode recreation module is configured to search the databases based on window-in-time parameters, wherein said window-in-time parameters specify a time interval.

13. The system of claim 8, wherein the episode recreation module is further configured to create at least one of a privacy restriction and a security restriction for a particular set of patient data.

14. The system of claim 8, wherein the plurality of databases comprise at least one of a physician notes database, a medical images database, a lab results database, a vital signs database, and a medications database; and wherein accessing comprises retrieving at least one of physician notes from the physician notes database, medical images from the medical images database, lab results from the lab results database, vital signs from the vital signs database, and medications from the medications database.

15. A computer-readable storage medium having stored therein computer-readable instructions, which, when loaded in and executed by a computer causes the computer to perform the steps of:
accessing a plurality of databases containing patient data corresponding to a particular patient;
integrating the patient data by correlating the patient data to a particular point-in-time.

16. The computer-readable storage medium of claim 1, wherein the integrating step comprises generating a patient-specific episode recreation data collection template (ERDCT).

17. The computer-readable storage medium of claim 16, further comprising computer-readable code for causing the computer to perform the step of creating a matrix, wherein said matrix comprises rows corresponding to time and columns corresponding to patient data.

18. The computer-readable storage medium of claim 1, wherein the integrating step further comprises at least one of time stamping and validating the patient data.

19. The computer-readable storage medium of claim 1, further comprising computer-readable code for causing the computer to perform the step of searching the databases based on window-in-time parameters, wherein said window-in-time parameters specify a time interval.

20. The computer-readable storage medium of claim 1, further comprising computer-readable code for causing the computer to perform the step of creating at least one of a privacy restriction and a security restriction for a particular set of patient data.

21. The computer-readable storage medium of claim 1, wherein the plurality of databases comprise at least one of a physician notes database, a medical images database, a lab results database, a vital signs database, and a medications database; and wherein the step of accessing comprises retrieving at least one of physician notes from the physician notes database, medical images from the medical images database, lab results from the lab results database, vital signs from the vital signs database, and medications from the medications database.
